(19) United States
(12) Patent Application Publication
(10) Pub. No.: US 2009/0289943 A1
(43) Pub. Date: Nov. 26, 2009

(54) Anti-aliasing system and method

(76) Inventor: Howard Teece, Winchester (GB)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(21) Appl. No.: 12/228,089

(22) Filed: May 22, 2008

(51) Int. Cl. G06T 11/00

(52) U.S. Cl. 345/467

(57) ABSTRACT

An anti-aliased font and a method of rendering an anti-aliased font. Rendering an anti-aliased pixel as a background color in the absence of an appropriate color to render the pixel if the level of anti-aliasing is less than a first level of anti-aliasing, and rendering the pixel as a foreground color if the level of anti-aliasing is greater than a second level of anti-aliasing.

### BACKGROUND OF THE INVENTION

The following published patents and patent applications are believed to reflect the present state of the art:

U.S. Pat. No. 7,002,597 to Arnold, et al;

U.S. Pat. No. 6,154,576 to Anderson, et al.;

U.S. Pat. No. 6,101,514 to Chan;

U.S. Pat. No. 5,940,080 to Ruehle, et al.;

U.S. Pat. No. 5,828,361 to Gibson;

U.S. Pat. No. 5,390,289 to Beitel et al.;

WO 2006/072755 of NDS Ltd.;

US 2002/0122045 of Woodson, et al.;

US 2002/0167530 of Hiratsuka et al.; and

US 2003/0095135 of Kaasila, et al.

### SUMMARY OF THE INVENTION

There is thus provided in accordance with a preferred embodiment of the present invention a method of rendering an anti-aliased font, the method including providing an anti-aliased font, and in the absence of an appropriate color to render an anti-aliased pixel if the level of anti-aliasing is less than a first level of anti-aliasing, rendering the pixel as a background color, and if the level of anti-aliasing is greater than a second level of anti-aliasing, rendering the pixel as a foreground color.

Further in accordance with an embodiment of the present invention the first level=50%±a margin of error.

Still further in accordance with an embodiment of the present invention the second level=50%±a margin of error.

Additionally in accordance with an embodiment of the present invention the margin of error does not exceed a quarter of the difference between the first level of anti-aliasing and the second level of anti-aliasing.

Moreover in accordance with an embodiment of the present invention the anti-aliased font is rendered on a set-top box.

Further in accordance with an embodiment of the present invention the anti-aliased font is rendered on a personal video recorder.

There is also provided in accordance with a another preferred embodiment of the present invention a method of designing an anti-aliased font, the method including designing a font including a plurality of characters, each character including a plurality of pixels, evaluating each pixel for each character in the font, in order to determine if the pixel requires anti-aliasing, and for each pixel requiring anti-aliasing, determining a level of anti-aliasing as follows if the level of anti-aliasing is less than a first level, setting the pixel to a background color, if the level of anti-aliasing is greater than the first level and less than a second level, setting the pixel to the first level of anti-aliasing, and assign the pixel, in an associated font mapping file, to display as a background color in the absence of an appropriate color to render the pixel, if the level of anti-aliasing is greater than the second level and less than a third level, setting the pixel to the second level of anti-aliasing, and assign the pixel, in an associated font mapping file, to display as a foreground color in the absence of an appropriate color to render the pixel, and if the level of anti-aliasing is greater than the third level, setting the pixel to the foreground color.

Further in accordance with an embodiment of the present invention the first level=33%±a margin of error.

Still further in accordance with an embodiment of the present invention the second level=50%±a margin of error.

Additionally in accordance with an embodiment of the present invention the third level=67%±a margin of error.

Moreover in accordance with an embodiment of the present invention the margin of error does not exceed a quarter of the difference between the first level of anti-aliasing and the second level of anti-aliasing.

There is also provided in accordance with still another preferred embodiment of the present invention an anti-aliased font including a plurality of characters, each character including a plurality of pixels, each pixel of each character having been evaluated in order to determine if the pixel requires anti-aliasing, and each pixel requiring anti-aliasing being assigned a level of anti-aliasing as follows if the level of anti-aliasing is less than a first level, the pixel is set to a background color, if the level of anti-aliasing is greater than the first level and less than a second level, the pixel is set to the first level of anti-aliasing, and assigned, in an associated font mapping file, to display as a background color in the absence of an appropriate color to render the pixel, if the level of anti-aliasing is greater than the second level and less than a third level, the pixel is set to the second level of anti-aliasing, and assigned, in an associated font mapping file, to display as a foreground color in the absence of an appropriate color to render the pixel, and if the level of anti-aliasing is greater than the third level, the pixel is set to the background color.

Further in accordance with an embodiment of the present invention the first level=33%±a margin of error.

Still further in accordance with an embodiment of the present invention the second level=50%±a margin of error.

Additionally in accordance with an embodiment of the present invention the third level=67%±a margin of error.

Moreover in accordance with an embodiment of the present invention the margin of error does not exceed a quarter of the difference between the first level of anti-aliasing and the second level of anti-aliasing.

Further in accordance with an embodiment of the present invention there is provided a display device including the font described above.

### BRIEF DESCRIPTION OF THE DRAWINGS

The present invention will be understood and appreciated more fully from the following detailed description, taken in conjunction with the drawings in which:

FIG. 1 is a simplified depiction of an italic letter l, depicted on an 8×11 grid;

FIG. 2 is a simplified representation of the italic letter l of FIG. 1, indicating foreground and background;

FIG. 3 is a simplified depiction of an anti-aliased italic letter l, depicted on an 8×11 grid;

FIG. 4 is a simplified representation of the italic letter l of FIG. 3, indicating foreground and background;

FIG. 5A is a simplified depiction of the anti-aliased italic letter l of FIG. 3 with anti-aliasing downgraded to the foreground;

FIG. 5B is a simplified depiction of the anti-aliased italic letter l of FIG. 3 with anti-aliasing downgraded to the background;

FIG. 6A is a representation of the letter W, indicating background;

FIG. 6B is a simplified depiction of the letter W of FIG. 6A, depicted on an 8×11 grid;

FIG. 7A is a representation of the letter W of FIG. 6A, indicating background and anti-aliasing information;

FIG. 7B is a simplified depiction of the anti-aliased letter W of FIG. 7A, depicted on an 8×11 grid;

FIG. 8A is a simplified depiction of the anti-aliased letter W of FIG. 7A of FIG. 6B with anti-aliasing downgraded to the foreground;

FIG. 8B is a simplified depiction of the anti-aliased letter W of FIG. 7A of FIG. 6B with anti-aliasing downgraded to the background;

FIG. 9 is a simplified depiction of the anti-aliased italic letter l of FIG. 3 with 50% anti-aliasing, depicted on an 8×11 grid;

FIG. 10 is a simplified representation of the italic letter l of FIG. 9, indicating foreground and background;

FIG. 11 is a simplified depiction of the anti-aliased italic letter l of FIG. 9, rendered in accordance with an embodiment of the present invention, depicted on an 8×11 grid; and

FIGS. 12 and 13 are simplified flowcharts of preferred methods of operation of the present invention.

The following Appendix may be helpful in understanding certain embodiments of the present invention:

Appendix A provides a listing of pseudo-code for implementing an embodiment of the present invention, and a translation of the pseudo-code to C.

### DETAILED DESCRIPTION OF A PREFERRED EMBODIMENT

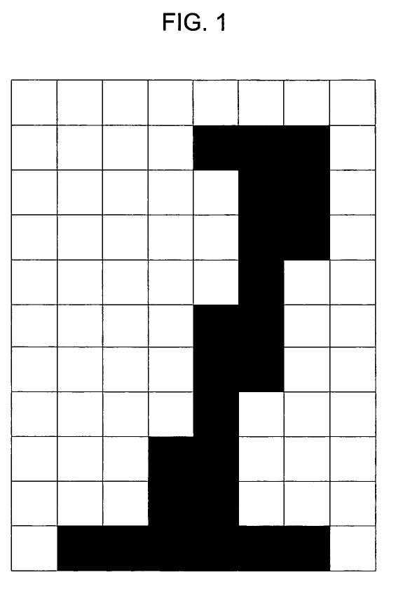

Reference is now made to FIG. 1, which is a simplified depiction of an italic letter l (l), depicted on an 8 by 11 grid. Depicting the l in the 8 by 11 grid enables considering the depicted l as an aggregation of pixels. When characters are rendered onto a display device, the characters can be depicted from a vector file that describes a path to be traced in order to depict the letter on the display device. Alternatively, the characters can be depicted from a pre-rendered image—known as a bitmap file. Bitmap files can describe any depth of character. That is to say, a full range of available color can be used to describe a character in a bitmap font. For example and without limiting the generality of the foregoing, in a 256 color-space, a depth of up to 256 colors is available to describe the character in the bitmap font.

Consider a character consisting of a background (such as the white of a page of paper) and a foreground (such as the black of type upon the white page of paper). Such a character can be described using a one-bit font: each pixel comprising the character is either a background pixel (for instance, 0) or a foreground pixel (for instance, 1). More complex font descriptions can increase the number of bits to allow for a blending between the foreground and the background; for example, a two-bit font gives three levels of foreground over the background (e.g. White (for instance, 00), Light Gray (for instance, 01), Dark Gray (for instance, 10), Black (for instance, 11)). Such a font representation system, referred to in the art as an “anti-aliasing system”, gives perceptibly better images to the eye, as any depicted curves and diagonals appear smoothed.

However, when only a limited number of colors are available for anti-aliasing, difficulties ensue. Typical font rendering devices include computers, set-top boxes, personal video recorders, and so forth. Those skilled in the art will appreciate that for the purposes of font rendering, set-top boxes, personal video recorders may be considered as one type of device. Although the description below specifically mentions set-top boxes, it is appreciated that doing so is for ease of description only, and in fact, the present invention may be implemented in any appropriate font rendering device.

By way of example of difficulties which may ensue when only a limited number of colors are available for anti-aliasing, where originally only 2 colors were needed to display a character, 4 are now required. However, on certain platforms such as some commercially available set-top boxes, only 256 colors are available. Typically, in such set-top boxes, 216 colors are assigned to display particular information, and the other 40 colors are assigned to displaying text. Normally, only a few colors are assigned in order to help with anti-aliasing, not assigning all the colors required, in such a limited color space. Analysis based on certain commercially available set top boxes shows that 56 additional colors are required to guarantee quality text output for such a set-top box running presently available user interfaces. It is generally accepted among those skilled in the art that in a finite color system there is a limited number of colors available for display, the limited number typically being less than the number of colors theoretically available.

In theory, it is possible, should a required anti-alias color not be available, to replace the unavailable color with either the foreground color or the background color. However, replacing the unavailable color with either the foreground color or the background color typically leads to poor shape definition, and therefore, hard-to-read text.

In theory, a set-top box could have two font definitions, one that has the anti-aliasing data and one that does not have the anti-aliasing data which can be used as a fallback font. However, having two such font definitions means that the set-top box stores both font definitions, and typically ROM space within a set-top box is at a premium.

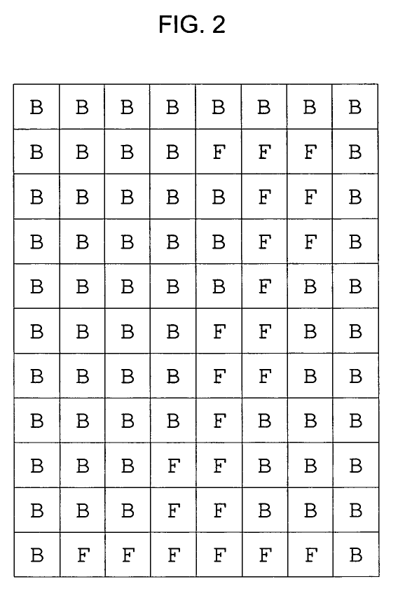

Reference is now additionally made to FIG. 2, which is a simplified representation of the italic letter l of FIG. 1, indicating foreground and background. A box in the grid depicted not filled-in in FIG. 1 is depicted with an F in FIG. 2, where F denotes foreground color (typically a 1 in a bitmap font). Correspondingly, a box in the grid depicted filled-in in FIG. 1 is depicted with a B in FIG. 2, where B denotes background color (typically a 0 in a bitmap font). The l depicted in FIGS. 1 and 2 is seen to be blocky and to have exceptionally rough edges.

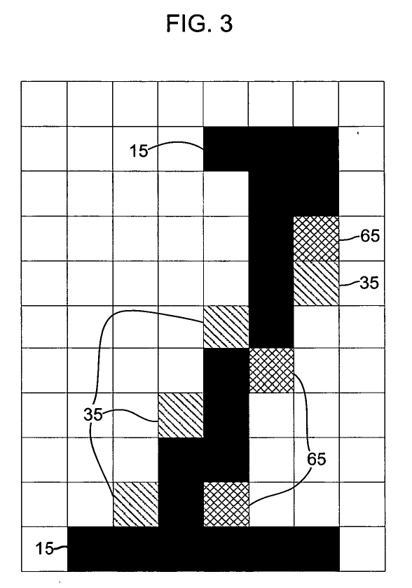

Reference is now made to FIG. 3, which is a simplified depiction of an anti-aliased italic letter l, depicted on an 8×11 grid. The anti-aliased italic letter l depicted in FIG. 3 has been anti-aliased using a two-bit font. Accordingly, there are three colors, in addition to the background, in use in the anti-aliased italic letter l depicted in FIG. 3: black 15, 35% gray 35, and 65% gray 65. When viewed from a distance, for example, when viewed on a viewing monitor, the anti-aliased italic letter l depicted in FIG. 3 appears smoother than the aliased italic letter l depicted in FIG. 1.

It is appreciated that percentages of gray scale as used in the present specification and claims are in fact understood to comprise a certain margin of error. Typically, the margin of error does not exceed a quarter of the difference between anti-aliased color steps. Therefore, in a system where the anti-aliasing step s between 33%-66%, for instance, there is a 33% difference, thus a 33%/4=8.25%. Thus, when a certain pixel is described as being 33% gray, or 50% gray, or 67% gray, it is understood, that the pixel in question may, in fact be respectively, for example, 40% gray, 48% gray, and 73% gray.

Those skilled in the art will appreciate that although in FIG. 3 percentages of gray scale used in anti-aliasing are described, by way of example as being, respectively, 35% and 65%, nevertheless, any appropriate first level and second level of gray scale may be used in anti-aliasing. A determination of proper gray scale levels is typically made by a qualified font designer.

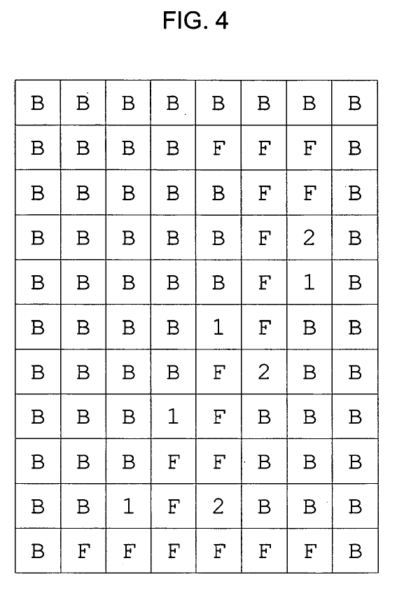

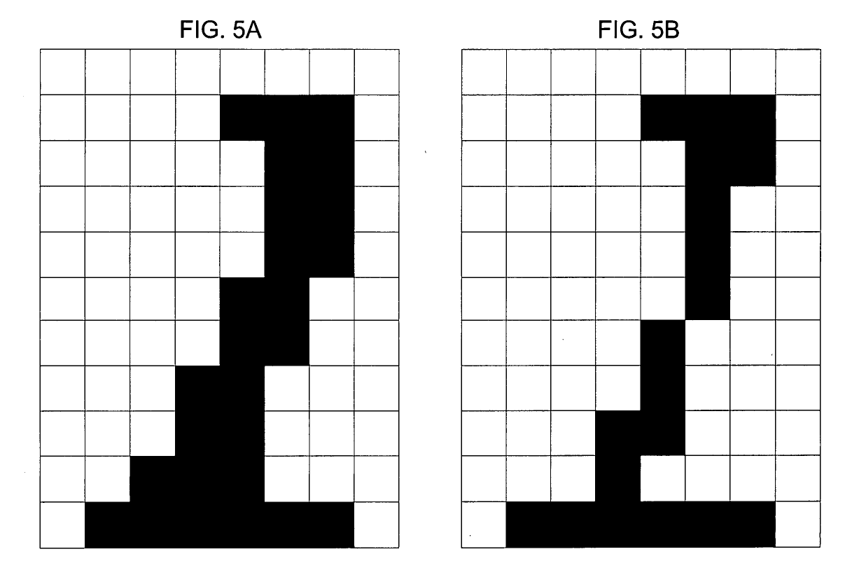

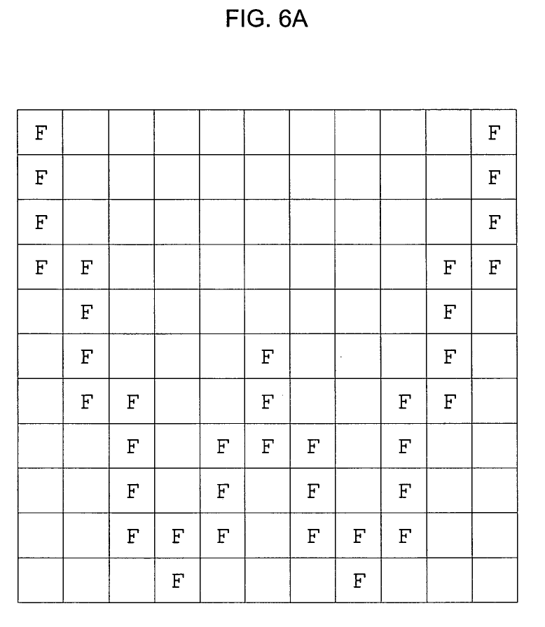

Reference is now additionally made to FIG. 4, which is a simplified representation of the italic letter l of FIG. 3, indicating foreground and background. In FIG. 4, as in FIG. 2, F denotes foreground color and B denotes background color. Additionally, 1 indicates that a ⅔ to ⅓ background to foreground mixture should be displayed. Likewise, 2 indicates that a ⅓ to ⅔ background to foreground mixture should be displayed. However, when at least one of the anti-aliasing colors is not available; it is not clear what color should be displayed. There are two options:
degrade to the foreground color; and
degrade to the background color.
   Either of the two options presented above will have a bad effect. In order to illustrate the bad effect of degrading to the foreground color, reference is now made to FIG. 5A, which is a simplified depiction of the anti-aliased italic letter l of FIG. 3 with anti-aliasing downgraded to the foreground. Likewise, in order to illustrate the bad effect of degrading to the foreground color, reference is now made to FIG. 5B, which is a simplified depiction of the anti-aliased italic letter l of FIG. 3 with anti-aliasing downgraded to the background.

The deleterious effect of downgrading anti-aliasing to either the foreground or the background is even more pronounced on letters with diagonal or curved portions, such as italicized upper case M (M) and upper case W. It is appreciated that the following discussion of the letters M and W is by way of example, and is applicable to many anti-aliased letters in certain fonts. In certain letters, such as, and without limiting the generality of the foregoing, M and W, anti-aliasing results in “spill”, also called “smear”. As a result of spill, not only are pixels which are foreground pixels colored with foreground coloring, but also certain pixels which neighbor foreground pixels are colored with anti-aliasing shades and colors. Often, the spill of the anti-aliased pixel to foreground results in a smudge.

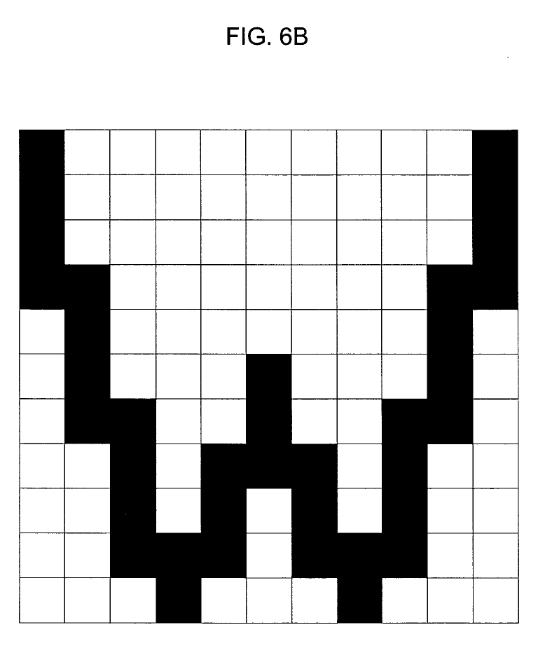

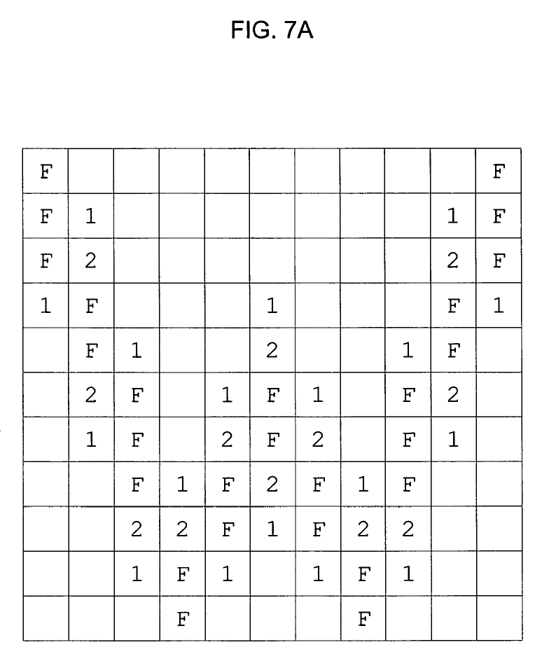

In order to highlight the above discussion of the deleterious effect of downgrading anti-aliasing on letters such as italicized upper case M (M) and upper case W, reference is now made to FIGS. 6A and 6B. FIG. 6A is a representation of the letter W, indicating foreground. FIG. 6B is a simplified depiction of the letter W of FIG. 6A, depicted on an 11×11 grid.

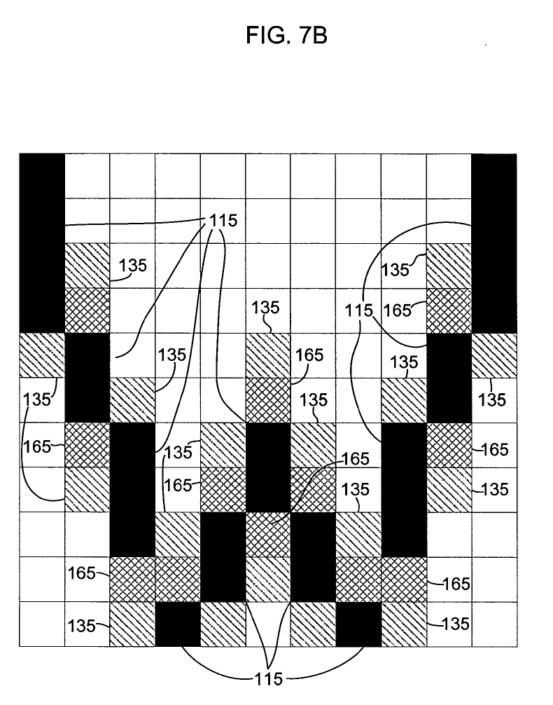

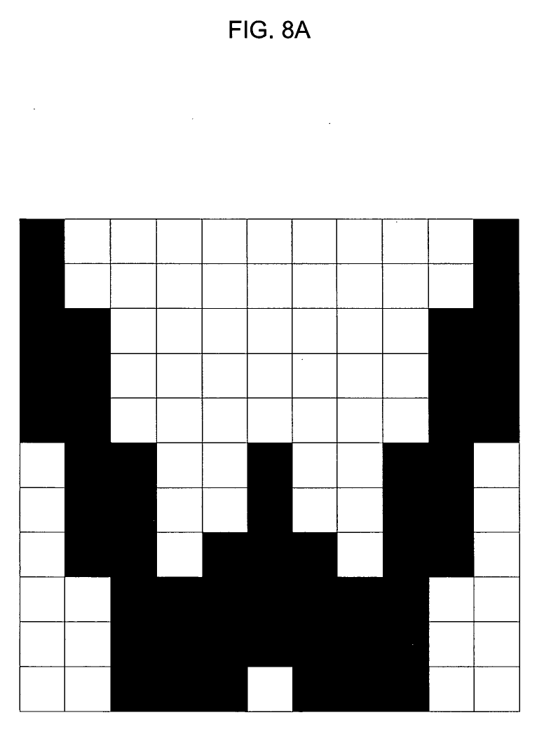

Reference is now made to FIGS. 7A and 7B. FIG. 7A is a representation of the letter W of FIG. 6A, indicating foreground and anti-aliasing information. In FIG. 7A, foreground color is assumed, and is not indicated, for ease of depiction. Additionally, 1 indicates that a ⅔ to ⅓ background to foreground mixture should be displayed. Likewise, 2 indicates that a ⅓ to ⅔ background to foreground mixture should be displayed.

FIG. 7B is a simplified depiction of the anti-aliased letter W of FIG. 7A, depicted on an 11×11 grid. The anti-aliased letter W depicted in FIG. 7B has been anti-aliased using a two-bit font. Accordingly, there are three colors, in addition to the background, in use in the anti-aliased letter W depicted in FIG. 7B: black 115, 35% gray 135, and 65% gray 165.

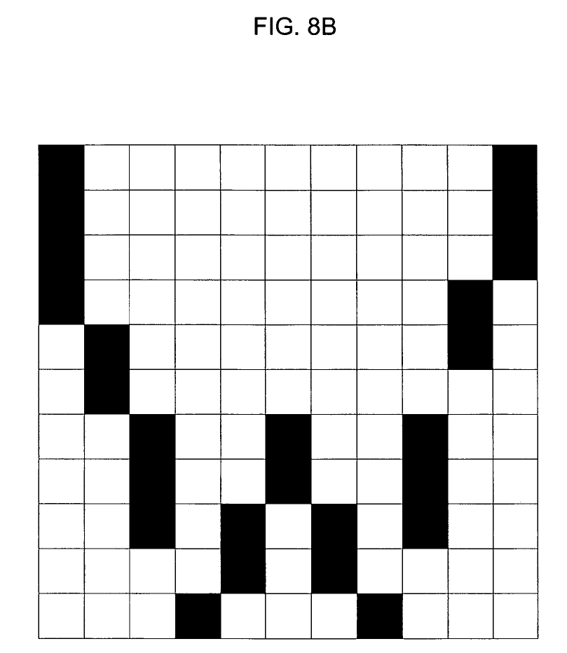

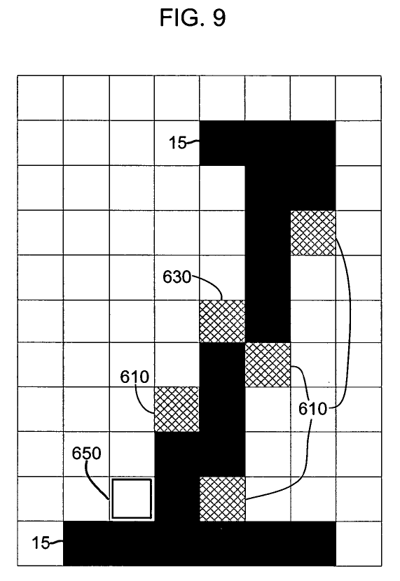

As mentioned above, the deleterious effect of downgrading anti-aliasing to either the foreground or the background is even more pronounced on letters such as italicized upper case M (M) and upper case W. Accordingly, reference is now made to FIGS. 8A and 8B. FIG. 8A is a simplified depiction of the anti-aliased letter W of FIG. 7A of FIG. 6B with anti-aliasing downgraded to the foreground. FIG. 8B is a simplified depiction of the anti-aliased letter W of FIG. 7A of FIG. 6B with anti-aliasing downgraded to the background. FIGS. 8A and 8B emphasize the point that degrading the anti-aliasing color to the background color causes, in M and W, very thin upright strokes and letters which are difficult to read.

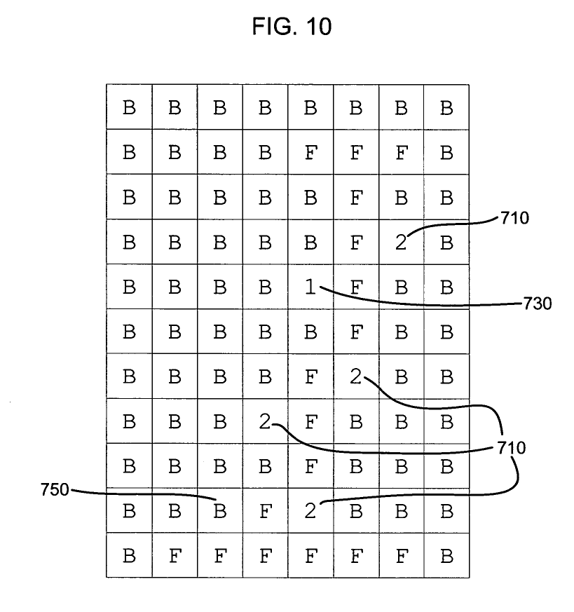

A font definition file at the rendering device typically comprises a collection of “steering maps”, the steering maps being similar to the depictions in FIG. 2 and FIG. 4. Such steering maps detail if a cell in the grid should be anti-aliased to 50%. It is appreciated that using 50% anti-aliasing causes a slight loss of smoothing. On the other hand, using 50% anti-aliasing instructs a rendering agent as to whether the cell in the grid should be colored with the foreground color or the background color, if the desired anti-aliasing color is not available. By way of example, reference is now made to FIG. 9, which is a simplified depiction of the anti-aliased italic letter l of FIG. 3 with 50% anti-aliasing, depicted on an 8×11 grid.

Those skilled in the art will appreciate that although in FIGS. 2 and 4 percentages of gray scale used in anti-aliasing are shown, by way of example, as being 50%, nevertheless, any appropriate level of gray scale may be used in anti-aliasing. It is appreciated that, in the following discussion of FIGS. 9, 10, and 11, percentages of anti-aliasing are given by way of example only, and any appropriate levels of anti-aliasing may be used.

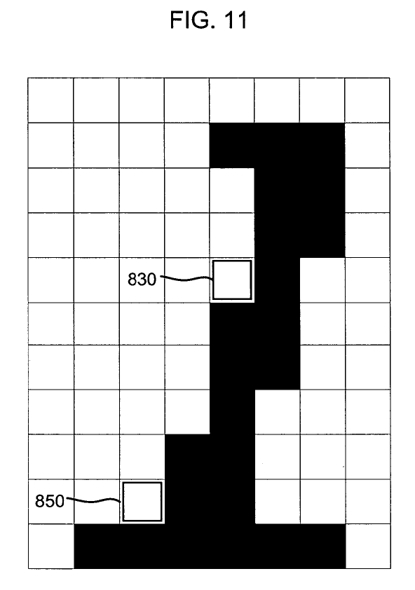

Reference is additionally made to FIG. 10, which is a simplified representation of the italic letter l of FIG. 9, indicating foreground and background. In FIG. 4, as in FIG. 2, F denotes foreground color and B denotes background color. Additionally, 1 indicates that a 50% anti-alias should be displayed, if the anti-alias color is available. Otherwise, the 50% anti-alias color should be replaced with the background color. Likewise, 2 indicates that a 50% anti-alias should be displayed, if the anti-alias color is available. Otherwise, the 50% anti-alias color should be replaced with the foreground color.

Accordingly, in FIG. 9 and FIG. 10, there are three colors in use in the anti-aliased italic letter l depicted: black 15, 50% gray 610, 630, and the background. Two of the squares of the grid of FIGS. 9 and 10 are of particular interest. In FIG. 9, a first square, indicated by numeral 630, corresponding to numeral 730 in FIG. 10 is of particular interest. The squares indicated by numeral 610 have anti-aliasing greater than 50% and less than 67%. Thus, in FIG. 9, the squares indicated by numeral 610 are depicted with 50% gray shading. Corresponding squares in FIG. 10 710 are depicted showing a 2. The square indicated by numeral 630, however, has an anti-aliasing value greater than 33% and less than 50%. Thus, in FIG. 9, the square indicated by numeral 630 is depicted with 50% gray shading. However, the corresponding square in FIG. 10, indicated with numeral 730, is depicting showing a 1.

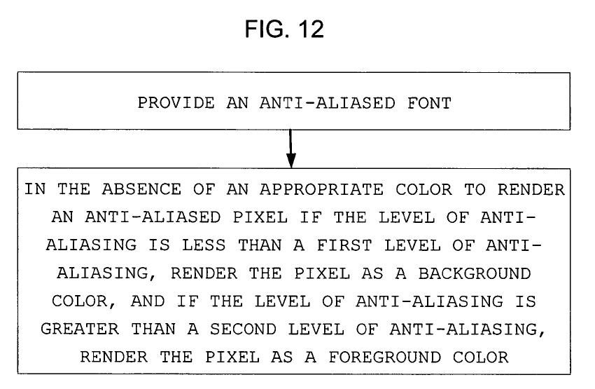

Reference is now additionally made to FIG. 11, which is a simplified pictorial illustration of the anti-aliased italic letter l of FIG. 9, rendered in accordance with an embodiment of the present invention, depicted on an 8×11 grid. In FIG. 11, it is seen that the squares corresponding to the squares in FIG. 9 identified with numeral 610 are depicted with anti-aliasing degraded to the foreground color, black. However, the square in FIG. 11 corresponding to the square indicated by numeral 630 in FIG. 9, indicated with numeral 830 in FIG. 11, is depicted with anti-aliasing degraded to the background color, white.

Likewise, the square indicated by numeral 650 would have an anti-aliasing value of 25%, and thus, in FIGS. 9, 10 and 11, corresponding squares indicated by numerals 650, 750, and 850 are depicted with the background color. By contrast, in the depiction of FIGS. 3 and 4, the corresponding square, being 35% anti-aliased, is depicted as shaded.

It is appreciated that FIG. 11, rendered in accordance with an embodiment of the present invention, is identical to FIG. 1.

Thus, in designing the font, each pixel to be rendered on a rendering device as an anti-aliased pixel, in an embodiment of the present invention, the anti-aliasing percentage is determined. If the anti-aliasing percentage is less than a first level of anti-aliasing, by way of example 33%, the pixel is rendered in the background color. If the anti-aliasing percentage is greater than the first level of anti-aliasing and less than a second level of anti-aliasing, by way of example 50%, the pixel is rendered as the background color. If the anti-aliasing percentage is greater than the second level of anti-aliasing and less than a third level of anti-aliasing, by way of example 67%, the pixel is rendered as the foreground color. If the anti-aliasing percentage is greater than the third level of anti-aliasing, the pixel is rendered as the foreground color. The boundary cases themselves would be as follows:
33% would be background;
50% would be foreground; and
67% would be foreground.

Those skilled in the art will appreciate that when actually rendering pixels of the font on the rendering device, in the absence of an appropriate anti-aliasing color:
if the level of anti-aliasing is less than a first level of anti-aliasing, the pixel is to be rendered as a background color; and
if the level of anti-aliasing is greater than a second level of anti-aliasing, the pixel is to be rendered as a foreground color.

By way of example, the first level of anti-aliasing and the second level of anti-aliasing discussed immediately above may both be 50%.

It is appreciated that the method described above must be taken into account in font design and in design of font rendering software. Industry standard software for producing and editing bitmap fonts is typically used; an example of such software is BitFonter, commercially available from FontLab Ltd. of 136 East 8th St., PMB 230, Port Angeles, Wash. 98362, USA.

Commercial font development software programs typically receive a vector file indicating design of a given character in a given font. The font development program typically outputs an 8-bit (256 shades of color) font as a bitmap. The resulting bitmap font is then imported into a software utility. The utility then reduces the 8-bit font to a 2-bit, anti-aliased font, as described herein.

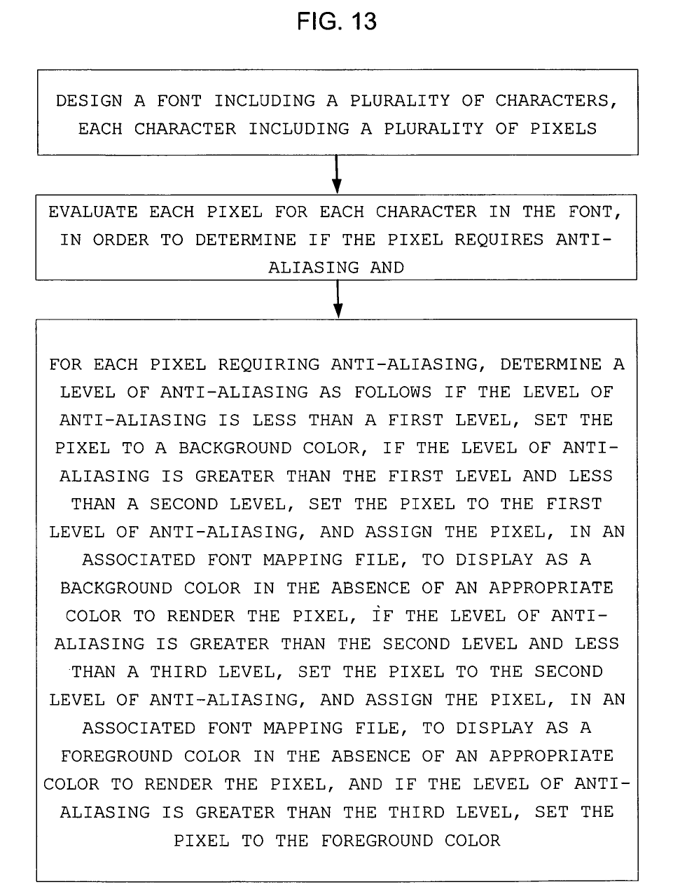

Reference is now made to FIGS. 12, and 13, which are simplified flowcharts of preferred methods of operation of the present invention

Reference is now made to Appendix A, which provides a listing of pseudo-code for implementing an embodiment of the present invention, and a translation of the pseudo-code to C.

It is appreciated that software components of the present invention may, if desired, be implemented in ROM (read only memory) form. The software components may, generally, be implemented in hardware, if desired, using conventional techniques.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined only by the claims which follow:

APPENDIX A
Appendix A provides a listing of pseudo-code for
implementing an embodiment of the present invention,
and a translation of the pseudo-code to C.

for_each Pixel in Letter

if Pixel is Background

then set Target to Background_Color

else if Pixel is Foreground

then set Target to Foreground_Color

else if Anti_Aliased_Color is available

then set Target to Anti_Aliased_Color

else if Pixel degrades to Background

then set Target to Background_Color

else if Pixel degrades to Foreground

then set Target to Foreground_Color

endif
advance Target based on Grid_Size of Letter

end_for_each
In C, the above pseudo-code would be:
void Render_Letter(Color *Target_Start, int Target_Width,
Character_Definition Letter)
{

Color *Target;
Color Anti_Alias_Color, Background_Color,
Foreground_Color;
Boolean Anti_Alias_Valid;
int x, y;
Anti_Alias_Valid =
GetAntiAliasColor(&Anti_Alias_Color);
GetBackgroundColor(&Background_Color);
GetForegroundColor(&Foreground_Color);
for (y = 0; y < Letter.height; y ++)
{

/* Set where we're going to write the colors */
Target = Target_Start + (Target_Width * y);
for (x = 0; x < Letter.width; x ++)
{

/* First check to see if normal color */
if (Letter[y][x] == BACKGROUND)
{

*Target = Background_Color;

}
else if (Letter[y][x] == FOREGROUND)
{

*Target = Foreground_Color;

}
/* Must be an anti-aliased color */
else if (Anti_Alias_Valid)
{

*Target = Anti_Alias_Color;

}
/* We don't have the color, degrade */
else if (Letter[y][x] ==

ANTI_ALIAS_BACKGROUND)

{

*Target = Background_Color;

}
else /* Must be (Letter[y][x] ==

ANTI_ALIAS_FOREGROUND) */

{

*Target = Foreground_Color;

}
Target += 1;

}

}

}

1. A method of rendering an anti-aliased font, the method comprising:
providing an anti-aliased font; and
in the absence of an appropriate color to render an anti-aliased pixel:
if the level of anti-aliasing is less than a first level of anti-aliasing, rendering the pixel as a background color; and
if the level of anti-aliasing is greater than a second level of anti-aliasing, rendering the pixel as a foreground color.

2. The method according to claim 1 and wherein the first level=50%±a margin of error.

3. The method according to claim 1 and wherein the second level=50%±a margin of error.

4. The method according to claim 2 and wherein the margin of error does not exceed a quarter of the difference between the first level of anti-aliasing and the second level of anti-aliasing.

5. The method according to claim 1 and wherein the anti-aliased font is rendered on a set-top box.

6. The method according to claim 1 and wherein the anti-aliased font is rendered on a personal video recorder.

7. A method of designing an anti-aliased font, the method comprising:
designing a font comprising a plurality of characters, each character comprising a plurality of pixels;
evaluating each pixel for each character in the font, in order to determine if the pixel requires anti-aliasing; and
for each pixel requiring anti-aliasing, determining a level of anti-aliasing as follows:
if the level of anti-aliasing is less than a first level, setting the pixel to a background color;
if the level of anti-aliasing is greater than the first level and less than a second level, setting the pixel to the first level of anti-aliasing, and assign the pixel, in an associated font mapping file, to display as a background color in the absence of an appropriate color to render the pixel;
if the level of anti-aliasing is greater than the second level and less than a third level, setting the pixel to the second level of anti-aliasing, and assign the pixel, in an associated font mapping file, to display as a foreground color in the absence of an appropriate color to render the pixel; and
if the level of anti-aliasing is greater than the third level, setting the pixel to the foreground color.

8. The method according to claim 7 and wherein the first level=33%±a margin of error.

9. The method according to claim 7 and wherein the second level=50%±a margin of error.

10. The method according to claim 7 and wherein the third level=67%±a margin of error.

11. The method according to claim 8 and wherein the margin of error does not exceed a quarter of the difference between the first level of anti-aliasing and the second level of anti-aliasing.

12. An anti-aliased font comprising:
a plurality of characters, each character comprising a plurality of pixels, each pixel of each character having been evaluated in order to determine if the pixel requires anti-aliasing; and
each pixel requiring anti-aliasing being assigned a level of anti-aliasing as follows:
if the level of anti-aliasing is less than a first level, the pixel is set to a background color;
if the level of anti-aliasing is greater than the first level and less than a second level, the pixel is set to the first level of anti-aliasing, and assigned, in an associated font mapping file, to display as a background color in the absence of an appropriate color to render the pixel;
if the level of anti-aliasing is greater than the second level and less than a third level, the pixel is set to the second level of anti-aliasing, and assigned, in an associated font mapping file, to display as a foreground color in the absence of an appropriate color to render the pixel; and
if the level of anti-aliasing is greater than the third level, the pixel is set to the background color.

13. The font according to claim 12 and wherein the first level=33%±a margin of error.

14. The font according to claim 12 and wherein the second level=50%±a margin of error.

15. The font according to claim 12 and wherein the third level=67%±a margin of error.

16. The font according to claim 13 and wherein the margin of error does not exceed a quarter of the difference between the first level of anti-aliasing and the second level of anti-aliasing.

17. A display device comprising the font according to claim 12.

18-21. (canceled)
